(19) United States
(12) Patent Application Publication
(10) Pub. No.: US 2022/0101806 A1
(43) Pub. Date: Mar. 31, 2022

(54) DISPLAY DEVICE AND METHOD

(71) Applicant: Japan Display Inc., Tokyo (JP)

(72) Inventor: Junji KOBASHI, Tokyo (JP)

(73) Assignee: Japan Display Inc., Tokyo (JP)

(21) Appl. No.: 17/550,568

(22) Filed: Dec. 14, 2021

Related U.S. Application Data
(63) Continuation of application No. PCT/JP2020/006919, filed on Feb. 20, 2020.

(30) Foreign Application Priority Data
Jun. 17, 2019 (JP) 2019-112019

(51) Int. Cl. G09G 3/36

(52) U.S. Cl. CPC G09G 3/36; G09G 2310/08; G09G 2320/0247; G09G 2320/0271; G09G 2320/0626

(57) ABSTRACT

According to one embodiment, a display device includes a display panel provided with a pixel and a display controller configured to drive the pixel based on a pixel signal for displaying an image in a predetermined gradation to display the image. The display controller is configured to drive the pixel with first luminance during a first subframe period of a plurality of subframe periods into which a one-frame period for displaying the image is divided and drive the pixel with second luminance during a second subframe period other than the first subframe period of the plurality of subframe periods to display the image in the predetermined gradation. A luminance difference between the first luminance and the second luminance is equal to or less than a predetermined value.

### CROSS-REFERENCE TO RELATED APPLICATIONS

This application is a Continuation Application of PCT Application No. PCT/JP2020/006919, filed Feb. 20, 2020 and based upon and claiming the benefit of priority from Japanese Patent Application No. 2019-112019, filed Jun. 17, 2019, the entire contents of all of which are incorporated herein by reference.

### FIELD

Embodiments described herein relate generally to a display device and a method.

### BACKGROUND

As a display device for displaying an image, for example, there is known a liquid crystal display device (transparent display) having a high transmittance to which a polymer dispersed liquid crystal (PDLC) is applied.

In such a display device, a relatively high voltage (drive voltage) needs to be applied to pixels when an image is displayed.

Therefore, for example, when the size of a chip on which a display controller (driver) for controlling the display of an image is implemented is reduced, the image can be displayed only in a limited number of gradations.

### BRIEF DESCRIPTION OF THE DRAWINGS

FIG. 1 is a plan view showing a configuration example of a display device according to an embodiment.

FIG. 2 is sectional view showing an example of a structure of the display device.

FIG. 3 is a schematic diagram illustrating a configuration of the display device.

FIG. 4 is a graph showing an example of a correspondence between a voltage applied to a pixel and the luminance of the pixel.

FIG. 5 is a table illustrating an example of gradations that can be represented by a display controller.

FIG. 6 is a diagram illustrating a case where pixels are driven with a constant luminance during a one-frame period.

FIG. 7 is a diagram illustrating a case where pixels are driven with different luminances for two subframe periods into which a one-frame period is divided.

FIG. 8 is an illustration of conversion of pixel signals.

FIG. 9 is a table showing an example of combinations of pixel luminances in first and second subframe periods.

FIG. 10 is a chart illustrating field sequential driving.

FIG. 11 is a table showing a specific example of luminance corresponding to each gradation.

FIG. 12 is a graph showing the luminance distribution of pixels in each of the first and second subframe periods to represent each gradation.

FIG. 13 is a graph showing a correspondence between the average luminance of pixels in the first and second subframe periods and the gradation corresponding to the average luminance.

FIG. 14 is a table showing an example of gradations represented in accordance with a combination of the pixel luminance in the first subframe period and the pixel luminance in the second subframe period.

FIG. 15 is an illustration of a configuration using FRC.

FIG. 16 is a graph showing an example of gradations that can be represented in the configuration using FRC.

FIG. 17 is a diagram illustrating a case where a luminance pattern is changed for each pixel in the configuration using FRC.

FIG. 18 is a table showing a specific example of luminance corresponding to each gradation when a one-frame period is divided into three subframe periods.

FIG. 19 is a diagram showing the luminance distribution of pixels in each of the three subframe periods into which a one-frame period is divided.

### DETAILED DESCRIPTION

In general, according to one embodiment, a display device includes a display panel provided with a pixel and a display controller configured to drive the pixel based on a pixel signal for displaying an image in a predetermined gradation to display the image. The display controller is configured to drive the pixel with first luminance during a first subframe period of a plurality of subframe periods into which a one-frame period for displaying the image is divided and drive the pixel with second luminance during a second subframe period other than the first subframe period of the plurality of subframe periods to display the image in the predetermined gradation. A luminance difference between the first luminance and the second luminance is equal to or less than a predetermined value.

Embodiments will be described hereinafter with reference to the accompanying drawings. The disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same or similar elements as or to those described in connection with preceding drawings or those exhibiting similar functions are denoted by like reference numerals, and a detailed description thereof is omitted unless otherwise necessary.

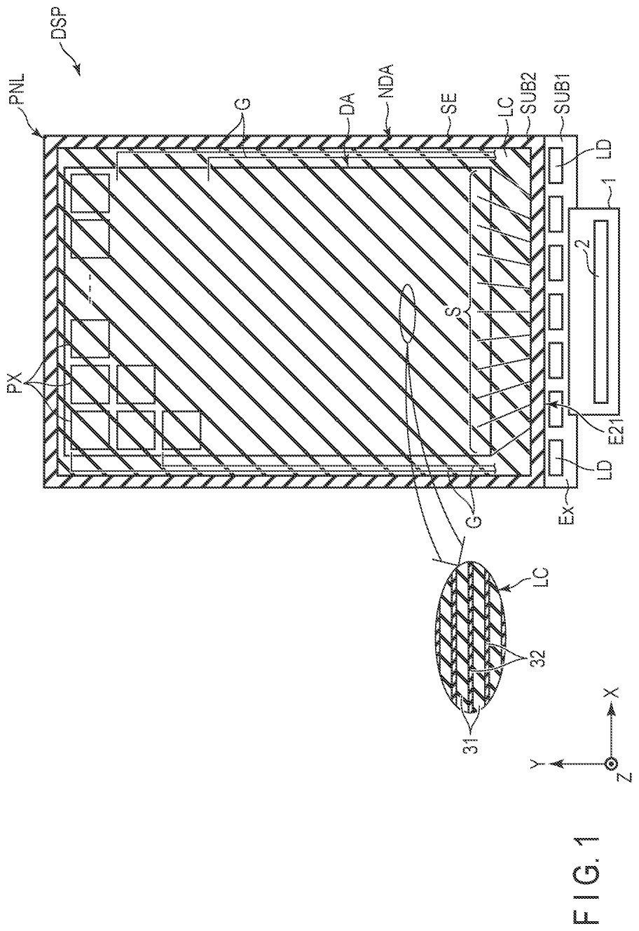

FIG. 1 is a plan view showing a configuration example of a display device DSP according to an embodiment. In the present embodiment, a liquid crystal display device to which a polymer dispersed liquid crystal (PDLC) is applied will be described as an example of the display device DSP. Note that the liquid crystal display device to which the PDLC is applied is used as a transparent display having a high transmittance.

In FIG. 1, a first direction X, a second direction Y and a third direction Z are orthogonal to each other, but may intersect at an angle other than ninety degrees. The first direction X and the second direction Y correspond to directions parallel to a main surface of a substrate which constitutes the display device DSP, and the third direction Z corresponds to a thickness direction of the display device DSP. In the following descriptions, viewing from above downward onto an X-Y plane defined by the first direction X and the second direction Y is referred to as planar view.

The display device DSP shown in FIG. 1 includes a display panel PNL, a wiring substrate 1, a display controller 2 and a plurality of light emitting elements LD.

The display panel PNL includes a first substrate SUB1, a second substrate SUB2, a liquid crystal layer LC, a seal SE, and the like. The first substrate SUB1 and second substrate SUB2 are formed in a flat plate shape parallel to the X-Y plane. The first substrate SUB1 and second substrate SUB2 are arranged at positions opposed to each other and bonded by the seal SE. The liquid crystal layer LC is held (arranged) between the first substrate SUB1 and second substrate SUB2 and is sealed by the seal SE.

As shown schematically in an enlarged scale in FIG. 1, the liquid crystal layer LC (PDLC) includes a polymer 31 and liquid crystal molecules 32.

The polymer 31 is a liquid crystal polymer having a strip-shaped structure. Specifically, the polymer 31 is formed in a strip shape extending along the first direction X and arranged in the second direction Y. The liquid crystal molecules 32 are dispersed in gaps of the polymer 31, and their long axes are aligned along the first direction X. Each of the polymer 31 and liquid crystal molecules 32 has optical anisotropy or refractive anisotropy. The responsiveness of the polymer 31 to the electric field is lower than that of the liquid crystal molecules 32 to the electric field.

The alignment direction of the polymer 31 hardly changes regardless of the presence or absence of an electric field. On the other hand, the alignment direction of the liquid crystal molecules 32 changes according to an electric field while a voltage higher than a threshold value is applied to the liquid crystal layer LC. While no voltage is applied to the liquid crystal layer LC, the optical axes of the polymer 31 and liquid crystal molecules 32 are parallel to each other, and light incident upon the liquid crystal layer LC is hardly scattered in the liquid crystal layer LC but is transmitted therethrough (transparent state). While a voltage is applied to the liquid crystal layer LC, the optical axes of the polymer 31 and liquid crystal molecules 32 cross each other, and light incident upon the liquid crystal layer LC is scattered in the liquid crystal layer LC (scattering state).

The display panel PNL includes a display area DA for displaying an image and a frame-shaped non-display area NDA surrounding the display area DA. The seal SE is located in the non-display area NDA. The display area DA includes pixels PX arranged in a matrix in the first direction X and second direction Y. The pixels PX each include a switching element and the like. The switching element is formed of, for example, a thin film transistor (TFT), and is electrically connected to a scanning line G and a signal line S.

The wiring substrate 1 is mounted on an extended portion Ex of the first substrate SUB1. The extended portion Ex corresponds to a portion of the first substrate SUB1 that is not superposed on the second substrate SUB2. The wiring substrate 1 is, for example, a foldable flexible printed circuit board. The display controller 2 is mounted on the wiring substrate 1. The display controller 2 is implemented as, for example, an IC chip, and drives the pixels PX based on a pixel signal for displaying an image in a predetermined gradation. The display controller 2 drives the pixels PX in this manner to display an image on the display panel PNL (display area DA). Note that the display controller 2 (IC chip) may be mounted on the extension portion Ex.

The light emitting elements (light sources) LD are arranged at positions superposed on the extended portion Ex in planar view. The light emitting elements LD are each, for example, a light emitting diode (LED) and are arranged at intervals along the first direction X. The light emitting elements LD also include light emitting elements having different light emitting colors. Specifically, the light emitting elements LD include, for example, a red light emitting element (red light source) that emits red light, a green light emitting element (green light source) that emits green light, and a blue light emitting element (blue light source) that emits blue light. The light emitting elements LD are arranged along the end portion E21 of the second substrate SUB2 to emit light toward the end portion E21. The end portion E21 extends along the first direction X in planar view. Note that as the light emitting elements LD, for example, a laser diode (LD) may be used.

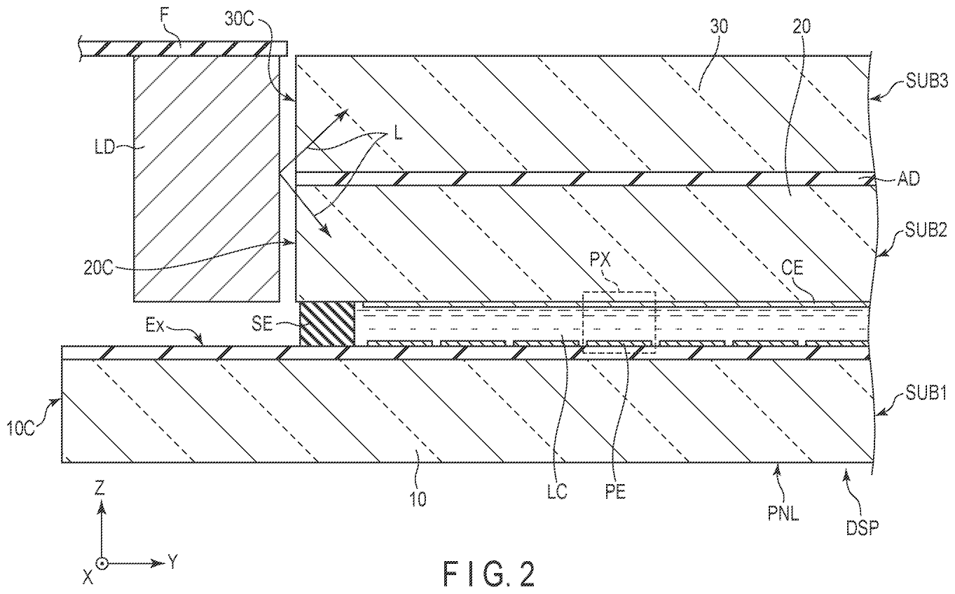

FIG. 2 shows a sectional view showing an example of a structure of the display device DSP of the present embodiment. As for the display panel PNL, its main part is only shown in FIG. 2.

The first substrate SUB1 includes a transparent substrate 10 and pixel electrodes PE. The pixel electrodes PE are provided for their respective pixels PX.

The second substrate SUB2 includes a transparent substrate 20 and a common electrode CE. The common electrode CE is placed over the pixels PX and opposed to the pixel electrodes PE in the third direction Z.

A liquid crystal layer LC, which is sealed by the seal SE, is located between the first and second substrates SUB1 and SUB2.

Note that FIG. 2 does not show switching elements provided in the pixels PX, scanning and signal lines connected to the switching elements, alignment films covering the pixel electrodes PE, alignment films covering the common electrode CE, or the like.

The display panel PNL further includes a transparent substrate 30. The transparent substrate 30 is bonded to the transparent substrate 20 by a transparent adhesive layer AD. Note that the transparent substrate 30 may not be provided.

The transparent substrates 10, 20 and 30 are insulating substrates such as glass substrates and plastic substrates, and have the same refractive index. The adhesive layer AD has the same refractive index as that of the transparent substrates 10, 20 and 30.

The transparent substrate 10 has a side surface 10C, the transparent substrate 20 has a side surface 20C, and the transparent substrate 30 has a side surface 30C. The side surface 20C corresponds to the end portion E21 of the second substrate SUB2 shown in FIG. 1. The extended portion Ex corresponds to a region between the side surfaces 10C and 20C along the second direction Y. The side surface 30C is located just above the side surface 20C.

As shown in FIG. 2, the light-emitting element LD faces the side surfaces 20C and 30C in the second direction Y. The light-emitting element LD is electrically connected to a wiring substrate F. Note that a transparent light guide may be placed between the light-emitting element LD and the side surfaces 20C and 30C.

Next is a description of light L emitted from the light-emitting element LD. As shown in FIG. 2, the light-emitting element LD emits light L toward the side surfaces 20C and 30C. The light L emitted from the light-emitting element LD travels along the direction of an arrow indicating the second direction Y, and enters the transparent substrate 20 from the side surface 20C and enters the transparent substrate 30 from the side surface 30C. The light L incident on the transparent substrates 20 and 30 travels inside the display panel PNL while being repeatedly reflected. The light L incident on the liquid crystal layer LC to which no voltage is applied passes through the liquid crystal layer LC with little being scattered. The light L incident on the liquid crystal layer LC to which a voltage is applied is scattered in the liquid crystal layer LC.

That is, when a liquid crystal display device (display device DSP) to which a polymer dispersed liquid crystal is applied is observed from the transparent substrate 10 side or the transparent substrate 30 side, light transmitted through the transparent substrate 10, liquid crystal layer LC, transparent substrate 20 and transparent substrate 30 is visually recognized in a state where a predetermined voltage is not applied to the liquid crystal layer LC (the pixel electrode PE or common electrode CE) (no voltage applied state). On the other hand, in a state where a predetermined voltage is applied to the liquid crystal layer LC (the pixel electrode PE and the common electrode CE) (voltage applied state), light from the light emitting element LD scattered in and emitted from the liquid crystal layer LC is visually recognized by the liquid crystal layer LC having a high scattering property.

It has been described that the liquid crystal layer LC has a high scattering property in a voltage applied state. If, for example, the optical axes of the polymer 31 and liquid crystal molecules 32 are made parallel to each other in a voltage applied state, the device can be so configured that the liquid crystal layer LC has a high scattering property in a no voltage applied state.

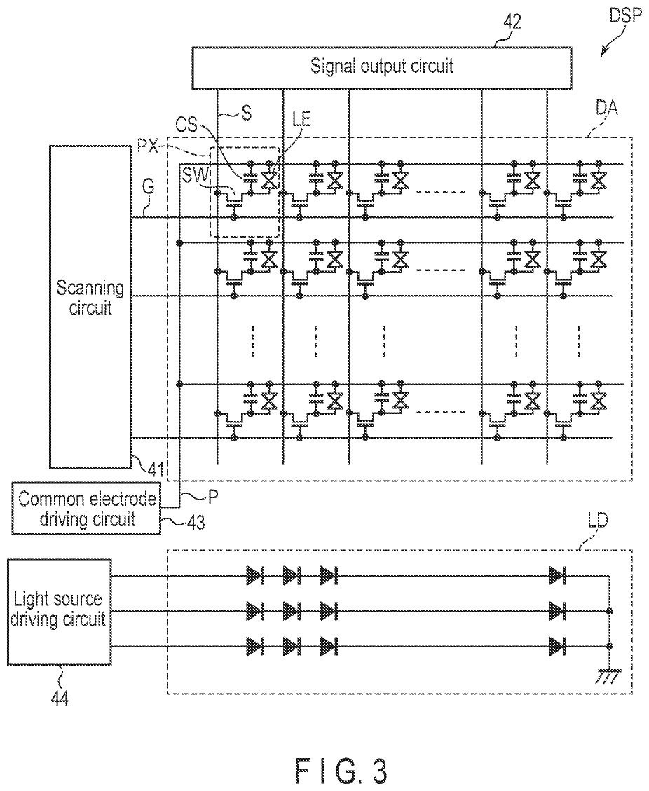

A schematic configuration of the display device DSP according to the present embodiment will be described below with reference to FIG. 3.

As shown in FIG. 3, the display device DSP has the foregoing display area DA, in which a plurality of pixels PX are arranged (arrayed) in a matrix.

The display device DSP also includes a scanning circuit 41, a signal output circuit 42, a common electrode driving circuit 43 and a light source (LED) driving circuit 44.

Furthermore, in the display area DA, a plurality of scanning lines (gate lines) G extending along the row direction of the pixels PX, a plurality of signal lines (source lines) S extending along the column direction of the pixels PX, and a power line P extending in parallel with the scanning lines G are arranged.

Each of the pixels PX is placed at an intersection of its corresponding scanning line G and signal line S.

Here is a description of the configuration of a pixel PX. As shown in FIG. 3, the pixel PX includes a pixel transistor (switching element) SW, a liquid crystal element LE, and the like.

The gate electrode of the pixel transistor SW is electrically connected to its corresponding scanning line G. One of the source and drain electrodes of the pixel transistor SW is electrically connected to its corresponding signal line S. The other of the source and drain electrodes of the pixel transistor SW is electrically connected to its corresponding liquid crystal element LE. In the following description, it is assumed that the source electrode of the pixel transistor SW is connected to the signal line S and the drain electrode of the pixel transistor SW is connected to the liquid crystal element LE.

Although not shown in FIG. 3, the liquid crystal element LE includes a liquid crystal layer LC, a pixel electrode PE and a common electrode CE. The pixel electrode PE is connected to the drain electrode of the pixel transistor SW, and the common electrode CE is connected to the power line P. In the present embodiment, the liquid crystal layer LC includes a polymer dispersed liquid crystal, and the liquid crystal element LE (display element) can be driven at a high speed so as to display an image (picture) at a refresh rate (frame rate) of about 180 Hz, for example.

The pixel PX (liquid crystal element LE) is driven by an electric field generated between the pixel electrode PE and the common electrode CE when a predetermined voltage is applied to the pixel electrode PE and the common electrode CE. Capacitance CS is formed, for example, between an electrode having the same potential as the common electrode CE and an electrode having the same potential as the pixel electrode PE.

The scanning circuit 41 is connected to the scanning lines G. The scanning circuit 41 applies an on-voltage and an off-voltage to the gate electrode of the pixel transistor SW, which is electrically connected to each scanning line G, via the scanning line G. When an on-voltage is applied to the gate electrode of the pixel transistor SW, the source and drain electrodes of the pixel transistor SW are electrically continuous with each other.

The signal output circuit 42 is connected to the signal lines S. The signal output circuit 42 supplies a pixel signal (output signal) to each pixel PX via each signal line S. The pixel signal is thus written to the pixel PX via the pixel transistor SW in which the source and drain electrodes are electrically continuous with each other.

The common electrode driving circuit 43 is connected to the power line P. The common electrode driving circuit 43 supplies a drive signal to the common electrode CE.

The light source driving circuit 44 is connected to the light emitting elements LD used as light sources in the display device DSP to drive each of the light emitting elements LD. Note that the light emitting elements LD include the foregoing red light emitting element, green light emitting element and blue light emitting element.

Although not shown in FIG. 3, the display controller 2 controls the driving of the scanning circuit 41, signal output circuit 42, common electrode driving circuit 43, light source driving circuit 44, etc. in order to control the operation of the display device DSP.

Below is a description of the operation of the display device DSP according to the present embodiment. The display device DSP according to the present embodiment is, for example, a liquid crystal display device (transparent display) to which a polymer dispersed liquid crystal is applied. In this display device DSP, a voltage to be applied to the pixels PX (liquid crystal elements LE) is higher than that in other display devices. Therefore, when the chip on which the display controller 2 (IC chip) is mounted is decreased in size for miniaturization or the like, an image can be displayed only in a limited gradation of, four example, 4 bits. It is thus assumed that the display device DSP (display controller 2) according to the present embodiment operates as described below in order to increase the number of gradations that can be represented when displaying an image.

First, an outline of the operation of the display device DSP according to the present embodiment for displaying an image will be described.

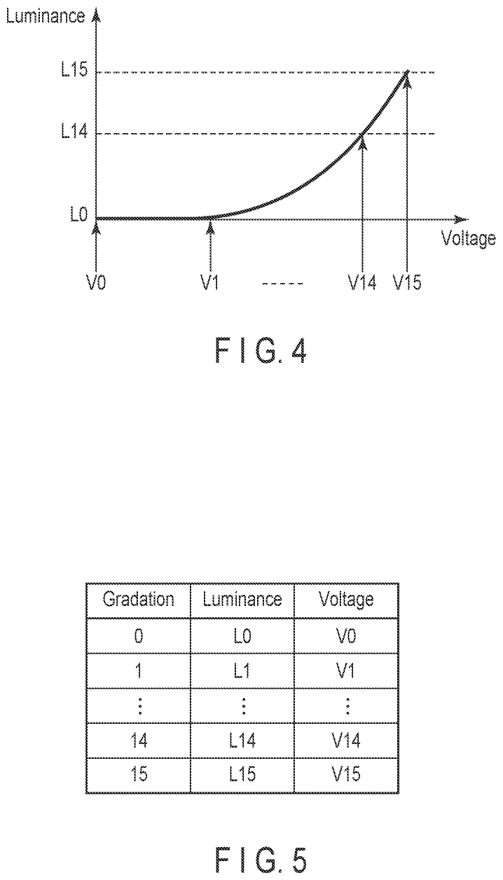

Assume here that a voltage to be applied to a pixel PX (liquid crystal element LE) based on a pixel signal is V and the luminance (luminance output from the pixel PX) of the pixel PX to which the voltage V is applied is L. In this case, there is a relationship shown in FIG. 4, for example between the voltage V and the luminance L. In the display device DSP according to the present embodiment, therefore, a pixel PX (liquid crystal layer LC) can be driven with a different luminance L by changing the voltage V applied to the pixel PX based on the pixel signal. The display device DSP displays an image by driving each of the pixels PX based on a pixel signal.

In the display device DSP according to the present embodiment, the display controller 2 is so configured that the pixels PX can be driven with a plurality of predetermined luminances L. Specifically, it is assumed that the display controller 2 can drive the pixels PX with luminances L0, L1, . . . , L14 and L15 corresponding to voltages V0, V1, . . . , V14 and V15, for example.

In addition, the luminance L of the pixels PX corresponds to a gradation that can be represented when an image is displayed. Therefore, according to the display controller 2 described above, as shown in FIG. 5, gradations of 0 to 15 (that is, gradations of 4 bits) corresponding to the luminances L0, L1, . . . , L14 and L15 can be represented.

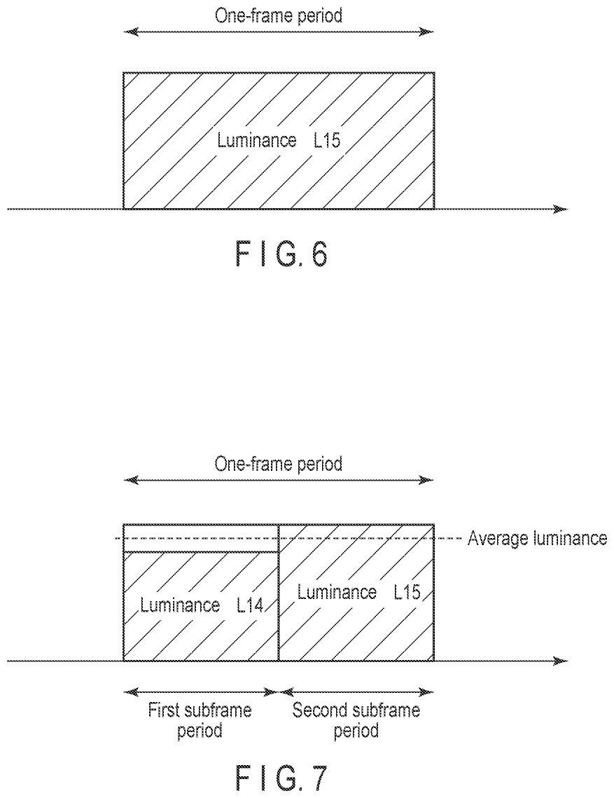

Assume here that the display controller 2 displays an image during a one-frame period based on a pixel signal. For example, as shown in FIG. 6, when a pixel PX is driven with the luminance L15 (voltage V15) during a one-frame period based on a pixel signal, the 15th one of the gradations 0 to 15, which corresponds to luminance L15, can be represented in the pixel PX. Although not shown, the same applies to the case where the pixel PX is driven with the luminance L other than the luminance L15. That is, when the pixel PX is driven with a constant luminance L during a one-frame period, the number of gradations that can be represented during the one-frame period is 16.

In contrast, in the display device DSP according to the present embodiment, as shown in FIG. 7, a one-frame period is divided into, for example, two sub-frame periods (first sub-frame period and second sub-frame period), and the display controller 2 drives a pixel PX with, for example, luminance L (voltage V) which varies from sub-frame period to sub-frame period. It is thus possible to represent a gradation corresponding to the average value (average luminance) of luminance L of pixels PX for each sub-frame period.

Specifically, when a pixel PX is driven with a constant luminance L during a one-frame period as shown in FIG. 6, for example, only the 15th gradation corresponding to luminance L15 or the 14th gradation corresponding to luminance L14 can be represented. In contrast, in the example shown in FIG. 7, a pixel PX is driven with luminance L14 (first luminance) during the first subframe period and it is driven with luminance L15 (second luminance) during the second subframe period to allow a gradation (a gradation between the 15th and 14th gradations) corresponding to the average luminance of luminance L14 and luminance L15 to be represented. Note that if the pixel PX is driven with luminance L15 during both the first and second subframe periods, a gradation corresponding to luminance L15 (the 15th gradation that can be represented by the display controller 2) can also be represented. Similarly, if the pixel PX is driven with luminance L14 during both the first and second subframe periods, a gradation corresponding to luminance L14 (the 14th gradation that can be represented by the display controller 2) can be represented.

As described above, in the present embodiment, the number of gradations that can be represented to display an image is increased by representing a gradation corresponding to the combination (average luminance) of a plurality of luminances L during each subframe period in addition to the 0 to 15 gradations that can originally be represented by the display controller 2.

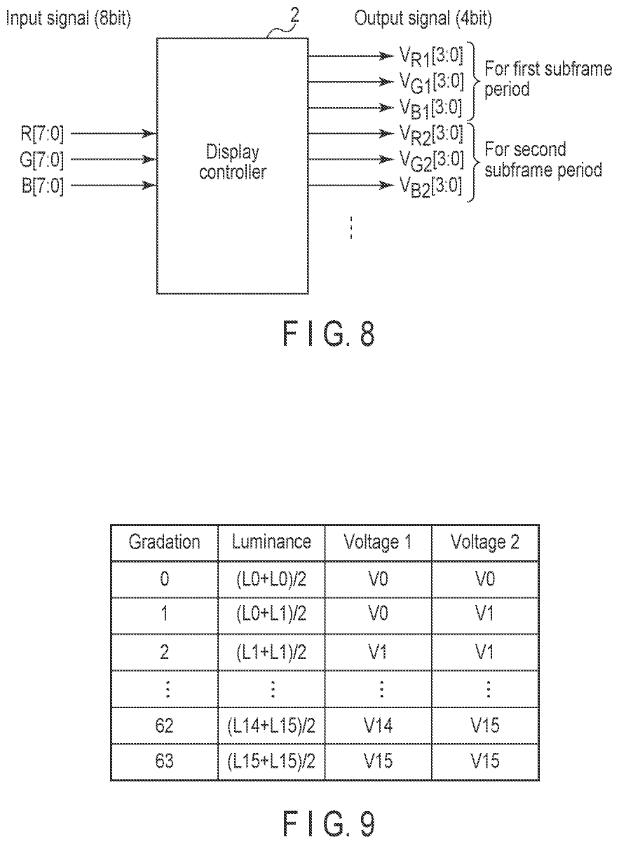

In the present embodiment, the display controller 2 inputs, for example, an 8-bit pixel signal as a pixel signal for displaying an image with a predetermined gradation. In this case, as shown in FIG. 8, the display controller 2 converts the 8-bit pixel signal (input signal) into a 4-bit pixel signal (output signal) for driving the pixel PX during the first subframe period and a 4-bit pixel signal (output signal) for driving the pixel PX during the second subframe period according to the gradation of an image to be displayed based on the 8-bit pixel signal to drive the pixel PX during the first and second subframe periods based on the converted pixel signals. It is shown in FIG. 8 that the red component (R), green component (G) and blue component (B) of the 8-bit pixel signal are converted into the red component (VR1), green component (VG1) and blue component (VB1) of the 4-bit pixel signal for the first subframe period and the red component (VR2), green component (VG2) and blue component (VB2) of the 4-bit pixel signal for the second subframe period.

Below is a description of the combination of the luminance of the pixel PX during the first subframe period and the luminance of the pixel PX during the second subframe period.

The description will be given here, assuming that the display controller 2 is configured to drive the pixel PX with the luminance L0 to L 15 as shown in FIG. 5, and defining the luminance of the pixel PX during the first subframe period as Li and defining the luminance of the pixel PX during the second subframe period as Lj.

Assuming in this case that each of the first and second subframe periods is sufficiently short, the luminance observed (viewed) during a one-frame period is (Li+Lj)/2 (that is, the average value of luminances Li and Lj). In other word, the gradation represented in the pixel PX in the present embodiment depends upon the combination (average luminance) of the luminance Li (applied voltage Vi) of the pixel PX in the first subframe period and the luminance Lj (applied voltage Vj) of the pixel PX in the second subframe period.

Since the gradation represented in the pixel PX may be adjusted so as to appear smoothly in consideration of the characteristics of the human eyes, for example, the average value of luminance L0 corresponding to the 0th gradation and luminance L2 corresponding to the second gradation (that is, (L0+L2)/2), which can be represented by the display controller 2, differs from the average value of luminance L1 corresponding to the first gradation and luminance L1 corresponding to the first gradation (that is, (L1+L1)/2=L1).

Thus, the combination of luminance Li of the pixel PX in the first subframe period and luminance Lj (gradation) of the pixel PX in the second subframe period for obtaining different average luminances (gradations) are ₁₆C₂+16=136. Specifically, there are ₁₆C₂ combinations excluding the overlapping in the case of Li≠Lj, and there are 16 combinations in the case of Li=Lj.

Among the foregoing 136 combinations of luminances Li and Lj, there are some combinations in which the average values of the luminances in the combinations are close to each other and thus a sufficient gradation difference cannot be obtained (that is, the gradation is reduced and cannot be represented appropriately).

In addition, when luminance L0 corresponding to the 0th gradation and luminance L15 corresponding to the 15th gradation are selected as the most extreme example, it is very likely that flicker will visually be recognized because a difference between the luminances is large.

Therefore, in the present embodiment, (the combinations of) luminances Li and Lj are selected (determined) such that the average luminances in the combinations do not overlap but a difference in luminance (that is, a difference in luminance between gradations) can avoid flicker. The combination of luminances Li and Lj is selected for each gradation to be represented.

Specifically, the luminances Li and Lj for representing each gradation are so selected that the average value of luminances Li and Lj does not overlap with the average value of luminances of the pixel PX in each of the first and second subframe periods when an image is displayed in a gradation other than the gradation (that is, there is such a difference equal to or larger than a predetermined value that a sufficient gradation difference can be maintained).

Furthermore, the luminance difference between luminance Li of the pixel PX in the first subframe period and luminance Lj of the pixel PX in the second subframe period is set to be 20% or less, more preferably 5% or less, of the luminance difference (that is, the maximum luminance difference) between luminance L0 (minimum luminance) corresponding to the 0th gradation and luminance L15 (maximum luminance) corresponding to the 15th gradation, which can be represented by the display controller 2. In order to satisfy this condition, the difference between the gradation corresponding to luminance Li of the pixel PX in the first subframe period and the gradation corresponding to luminance Lj of the pixel PX in the second subframe period is, for example, preferably 2 or less.

Accordingly, the luminance Li of the pixel PX in the first subframe period and the luminance Lj of the pixel PX in the second subframe period are selected as shown in FIG. 9, for example. In the example shown in FIG. 9, luminances L0 and L0 are selected as luminances Li and Lj representing, for example, the 0th gradation that can be represented in the display device DSP according to this embodiment. In addition, luminances L0 and L1 are selected as luminances Li and Lj representing, for example, the first gradation that can be represented in the display device DSP according to the present embodiment. The other gradations are as shown in FIG. 9, and their detailed descriptions will be omitted. In FIG. 9, a voltage applied to the pixel PX in the first subframe period is denoted as voltage 1, and a voltage applied to the pixel PX in the second subframe period is denoted as voltage 2.

In the case where the combination of luminances Li and Lj as shown in FIG. 9 is adopted, the gradation of 0 to 63 (namely, 6-bit gradation) can be represented in the display device DSP (pixel PX). FIG. 9 shows an example in which luminance Li of the pixel PX in the first subframe period and luminance Lj of the pixel PX in the second subframe period are increased alternately step by step. However, in order to achieve the 6-bit gradation, a combination of luminances Li and Lj corresponding to, for example, a two-gradation difference (for example, Li=L0, Lj=L2, etc.) may appropriately be selected.

Furthermore, in the present embodiment, in order to avoid a pseudo vibration of images, the luminance change between the first and second subframe periods is uniformed. Specifically, for example, the luminance of the pixel PX in a sub-frame period (second subframe period) positioned later than the a one-frame period is equal to or greater than the luminance of the pixel PX in a subframe period (first subframe period) positioned earlier than the one-frame period. The same applies to the other one-frame periods. That is, it is assumed that luminances Li and Lj are selected such that the relationship of “luminance Li of pixel PX in first subframe period≤luminance Lj of pixel PX in second subframe period” is always satisfied in each of the 0th to 63rd gradations represented in the display device DSP.

The relationship between luminance Li of the pixel PX in the first subframe period and luminance Lj of the pixel PX in the second subframe period may be, for example, “luminance Li of pixel PX in first subframe period luminance Lj of pixel PX in second subframe period”.

It has been so far described that in the present embodiment, the display controller 2 is configured to represent the 0th to 15th gradations. However, in the case where the luminance corresponding to the maximum gradation (here the 15th gradation) which can be represented by the display controller 2 is L_{M}, luminance L_{M-1} corresponding to the second-maximum gradation can be represented by the expression (2) using the following expression (1).

$$\begin{matrix}{( \frac{( N - 1 ) {L}_{M} + {L}_{M - 1}}{N} )}^{\frac{1}{γ}} = \frac{{M}^{′} - 1}{{M}^{′}} & Expression ( 1 ) \\ {L}_{M - 1} = N * {( \frac{{M}^{′} - 1}{{M}^{′}} )}^{γ} - ( N - 1 ) {L}_{M} & Expression ( 2 )\end{matrix}$$

In the expressions (1) and (2), N represents the number of subframe periods obtained by dividing a one-frame period (here, 2), and M′ represents the maximum gradation (63rd gradation) which can be represented by the display device DSP according to the present embodiment by dividing the one-frame period into a plurality of subframe periods. Note that luminance L_{M} corresponding to the maximum gradation that can be represented by the display controller 2 is equal to 1. Assume here that the voltage adjusted by the gamma curve 2.2 is used, and γ is equal to 2.2. Accordingly, luminance L_{M-1} can be calculated using the expression (2), and the luminance corresponding to the 14th gradation that can be represented by the display controller 2 can be determined using the luminance L_{M-1}. L_{M-1} represented by the above expression (2) may vary, for example, in the range of ±0.05 or ±0.03 (that is, in the range of several percent).

In addition, luminance L_{M-2} corresponding to a gradation that is lower than the gradation corresponding to the luminance L_{M-1} is determined so as to have a value within a range satisfying the following expression (3).

$$N * {( \frac{- 1 + ( N + 1 ) * {L}_{M - 1}^{\frac{1}{γ}}}{N} )}^{γ} - ( N - 1 ) \pm 0.05 \qquad Expression ( 3 )$$

The luminance L_{M-2} has been described. Luminance L_{M-3} et seq corresponding to a gradation that is lower than the gradation corresponding to the luminance L_{M-2} can similarly be determined.

In the present embodiment, luminances Li and Lj corresponding to the gradations of an image to be displayed are selected appropriately as described above to drive the pixel PX with luminance Li during the first subframe period and drive the pixel PX with luminance Lj during the second subframe period, with the result that a gradation corresponding to the combination of luminances Li and Lj (that is, the average luminance) can be represented. The luminances Li and Lj corresponding to each gradation may be selected (determined) in advance or may be selected (determined) dynamically by the display controller 2 in response to a pixel signal.

In the present embodiment, a one-frame period is divided into two subframe periods (first and second subframe periods) as described above. However, the number of subframe periods into which the one-frame period is divided (that is, N in the expressions (1) to (3)) may be three or more. Even in this case, a gradation corresponding to the average value of the luminances of the pixel PX in three or more subframe periods can be represented.

Assume in the present embodiment that a field sequential driving (method) is employed as a driving method of the display device DSP for displaying an image based on a pixel signal. The field sequential driving is a driving method for achieving color display by selecting red, green or blue light emission in each pixel PX in time division.

As described above, the display device DSP according to the present embodiment includes a red light emitting element, a green light emitting element, and a blue light emitting element LD as a plurality of light emitting elements LD, and the field sequential driving is achieved by sequentially driving the red light emitting element, green light emitting element and blue light emitting element.

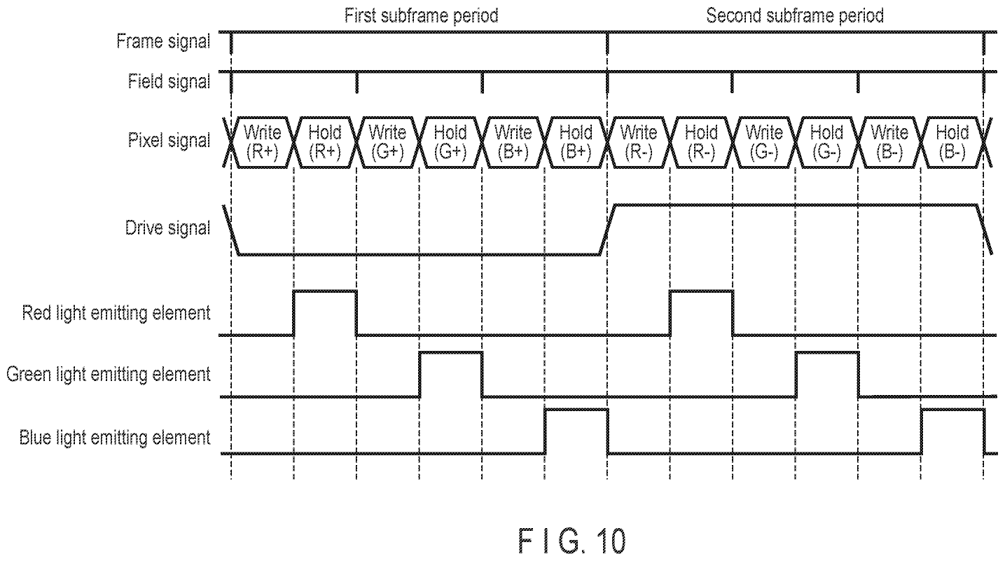

The field sequential driving in the display device DSP according to the present embodiment will briefly be described with reference to FIG. 10.

In the present embodiment, a one-frame period is divided into, for example, first and second subframe periods. The frame signal shown in FIG. 10 is a signal for switching between a one-frame period for displaying an image in the display area DA of the display device DSP and subframe periods into which the one-frame period is divided. The field signal is a signal for selecting a field in the field sequential driving.

In this case, for example, a first subframe period is divided, based on the frame signal, into a period for displaying an image of red components (red field) (referred to as R period hereinafter), a period for displaying an image of green components (green field) (referred to as G period hereinafter), and a period for displaying an image of blue components (blue field) (referred to as B period hereinafter).

In addition, each of the R period, G period and B period includes a period for writing a pixel signal into the pixel PX (referred to as write period hereinafter) and a period for causing the pixel PX to hold the pixel signal (referred to as holding period). In the write period, the foregoing scanning lines G are scanned in sequence and a pixel signal is applied to the signal line S to write the pixel signal to the pixel PX. During the holding period, the pixel PX holds a state in which a pixel signal is written, and its corresponding light-emitting element LD is caused to emit light (turned on).

Specifically, when, for example, a red light emitting element is caused to emit light, light (red incident light) enters the liquid crystal layer LC from the red light emitting element. In response to the pixel signal held in the pixel PX, a voltage is applied to the liquid crystal element LE (pixel electrode PE and common electrode CE) and accordingly the liquid crystal layer LC is brought into a scattered state and scattered light of the red incident light is emitted. A red field can thus be displayed.

It has been described above that a red field is displayed during the R period. The same applies to the case where a green light emitting element is caused to emit light to display a green field during the G period and the case where a blue light emitting element is caused to emit light to display a blue field during the B period.

That is, during the first subframe period, the pixel PX is driven with luminance Li based on the pixel signal (red component) in the R period, the pixel PX is driven with luminance Li based on the pixel signal (green component) in the G period, and the pixel PX is driven with luminance Li based on the pixel signal (blue component) in the B period. Note that the luminance Li with which the pixel PX is driven in each of the R period, G period and B period varies depending on the red, green and blue components in the pixel signal. The pixel signal for driving the pixel PX during the first subframe period is a 4-bit pixel signal for the first subframe period into which the 8-bit pixel signal is converted.

Though the first subframe period has been described above, the same applies to the second subframe period. During the second subframe period, the pixel PX is driven with luminance Lj based on the pixel signal (red component) in the R period, the pixel PX is driven with luminance Lj based on the pixel signal (green component) in the G period, and the pixel PX is driven with luminance Lj based on the pixel signal (blue component) in the B period. Note that the luminance Lj with which the pixel PX is driven in each of the R period, G period and B period varies depending on the red, green and blue components in the pixel signal. The pixel signal for driving the pixel PX during the second subframe period is a 4-bit pixel signal for the second subframe period into which the 8-bit pixel signal is converted.

In the present embodiment, as described above, the red, green and blue fields are displayed in sequence during the first subframe period (that is, the pixels PX are driven in sequence based on the respective color components) and they are displayed in sequence during the second subframe period (that is, the pixels PX are driven in sequence based on the respective color components) to represent a gradation corresponding to the average value of luminance Li and luminance Lj output from the pixel PX for each color.

Assume that the polarity of a voltage to be applied to the liquid crystal element LE (referred to as liquid crystal applied voltage hereinafter) is inverted for each subframe (period) because liquid crystal has to be driven in an alternating current. In this case, after the fields of positive polarity are displayed in sequence, the polarity of the liquid crystal applied voltage is reversed to perform inversion driving for displaying the fields of negative polarity in sequence. At this time, a drive signal to be applied to the common electrode CE is inverted for each subframe period according to the polarity of the liquid crystal applied voltage.

Though it has been described above that the polarity of the liquid crystal applied voltage is inverted for each subframe, it may be inverted for each frame or for each display line.

It has been described with reference to FIG. 10 that after the first subframe period for displaying the fields of their respective colors, a second subframe period for displaying the fields of their respective colors is similarly provided. However, for example, a second subframe period for displaying the red field may be provided after the first subframe period for displaying the red field, the second subframe period for displaying the green field after the first subframe period for displaying the green field, and a second subframe period for displaying the blue field after the first subframe period for displaying the blue field may be provided.

In addition, an example in which a red field, a green field and a blue field are displayed in this order has been described so far. However, the order of colors of the fields to be displayed (that is, the lighting order of the light emitting elements of respective colors) may be changed as appropriate.

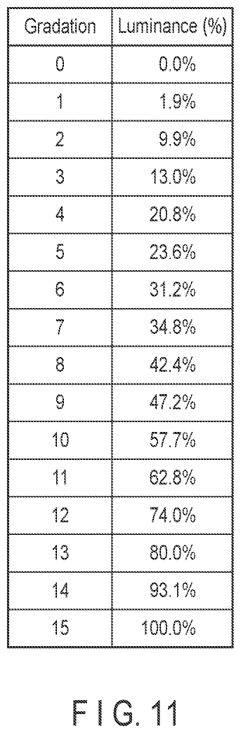

A specific example of the present embodiment will be described below. FIG. 11 shows an example of luminance corresponding to each of the 0th to 15th gradations that can be represented by the display controller 2. When the luminance corresponding to the 0th gradation is 0(%) and the luminance corresponding to the 15th gradation is 100(%), luminance (%) corresponding to each of the other gradations is shown in FIG. 11.

The gradations and luminances shown in FIG. 11 are separated from, for example, a general gamma curve 2.2 and determined as appropriate luminances (voltages) for 16 gradations. However, luminance (voltage) adjusted by the gamma curve 2.2 may be used.

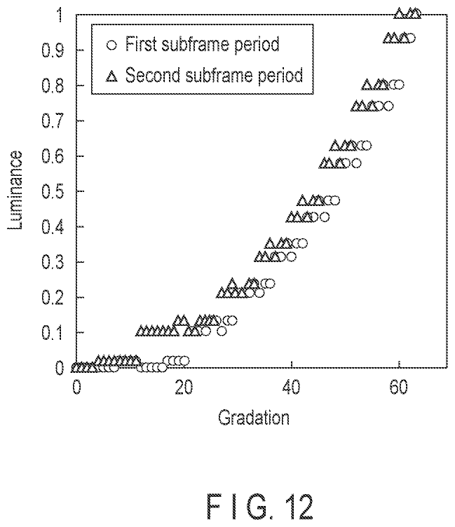

FIG. 12 shows the distribution of luminances of the pixel PX in each of the first and second subframe periods selected to represent, for example, the 0th to 63rd gradations in the display device DSP according to the present embodiment. As described above, the luminance of the pixel PX in the first subframe period and the luminance of the pixel PX in the second subframe period are selected such that a difference in the luminance becomes small and the luminances (average luminances) corresponding to the gradations do not overlap each other.

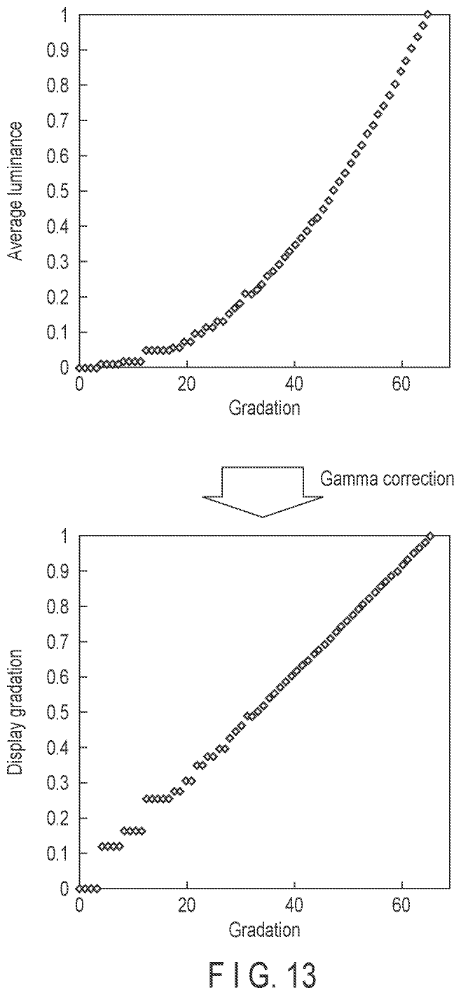

FIG. 13 shows the average luminance (average value) of the pixel PX in the first and second subframe periods shown in FIG. 12 and the gradation corresponding to the average luminance.

The upper part of FIG. 13 shows the average luminance corresponding to each gradation. The gradation shown in the lower part of FIG. 13 can be obtained by applying gamma correction to the correspondence between the gradation and the average luminance.

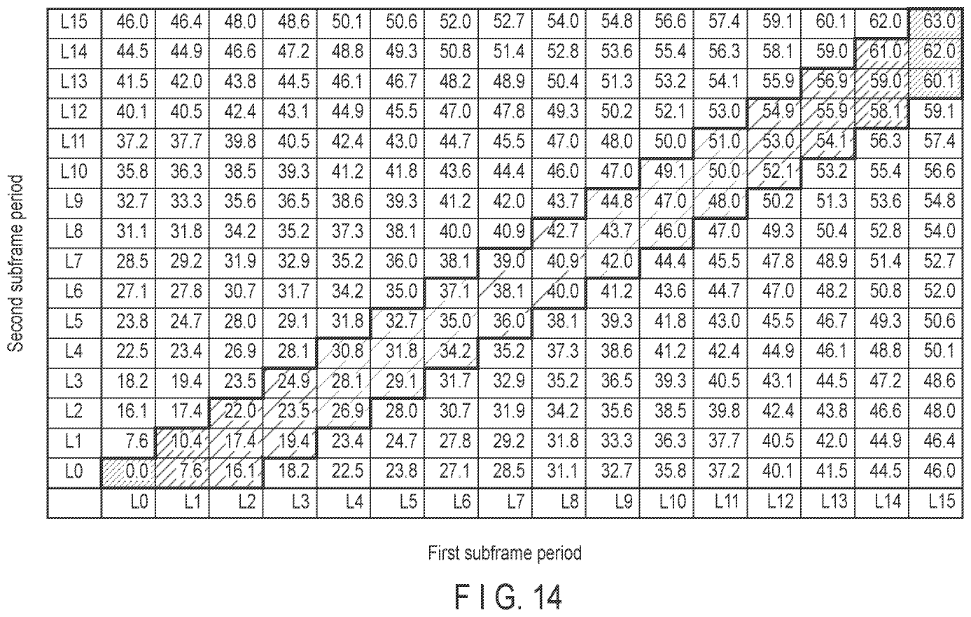

FIG. 14 shows an example of gradation represented in accordance with the combination of luminance (gradation) of the pixel PX in the first subframe period and luminance (gradation) of the pixel PX in the second subframe period shown in FIG. 12.

In FIG. 14, the hatched portions represent gradation values of gradation represented when an image is displayed in the present embodiment (that is, the combination of luminances selected to represent respective gradations). Specifically, in the example shown in FIG. 14, the 63rd gradation of the 0th to 63rd gradations is represented, for example, by setting the luminance of the pixel PX in the first subframe period to L15 and setting the luminance of the pixel PX in the second subframe period to L15. In addition, the 50th gradation of the 0th to 63rd gradations is represented, for example, by setting the luminance of the pixel PX in the first subframe period to L11 and setting the luminance of the pixel PX in the second subframe period to L10. For example, when the luminance of the pixel PX in the first subframe period is L10 and the luminance of the pixel PX in the second subframe period is L10, the gradation value is 49.1 and, in this case, the 49th gradation is represented. The same applies to the other gradations.

Furthermore, among the gradation values shown in FIG. 14, the gradation values of the portions which are not hatched (combinations of luminances of the pixel PX in the first and second subframe periods) are not used (adopted) because a difference in luminance between the pixels PX in the first and second subframe periods is large, or because the gradation values overlap each other, or the like.

The gradation (value) represented when an image is displayed in the present embodiment shown in FIG. 14 is obtained by selecting (determining) the luminance of the pixels PX in the first and second subframe periods by giving priority to, for example, the higher gradation. Note that, for example, depending on the maximum luminance of the light-emitting element LD, the luminance may be selected by giving priority to the lower gradation.

When the luminance of the pixel PX in the first and second subframe periods is determined by giving priority to the higher gradation as described above, there is a portion (gradation) which cannot be represented in the lower gradation as shown in FIGS. 13 and 14.

Assume in the above case that frame rate control (FRC) is used to further increase the number of gradations that can be represented. The FRC is a method for representing one gradation in a plurality of one-frame periods.

When the FRC is used, one gradation can be represented in, for example, two one-frame periods (that is, two sets of first and second subframe periods), as shown in FIG. 15.

Specifically, in the example shown in FIG. 15, the pixel PX is driven with luminance L1 (first luminance) in a first subframe period obtained by dividing a one-frame period, the pixel PX is driven with luminance L1 (second luminance) in a second subframe period, the pixel PX is driven with luminance L1 (third luminance) in a first subframe period (third subframe period) obtained by dividing a one-frame period following the one-frame period, and the pixel PX is driven with luminance L2 (fourth luminance) in a second subframe period (fourth subframe period), thereby displaying an image with a predetermined gradation based on a pixel signal.

According to the above, only in the one-frame period (first and second subframe periods), no gradation other than a gradation corresponding to the average luminance ((L1+L2)/2) of luminances L1 and L2 can be represented. If, however, one gradation is represented in two one-frame periods, a gradation corresponding to the average luminance of luminances L1, L1, L1 and L2 ((L1+L1+L1+L2)/4) can be represented.

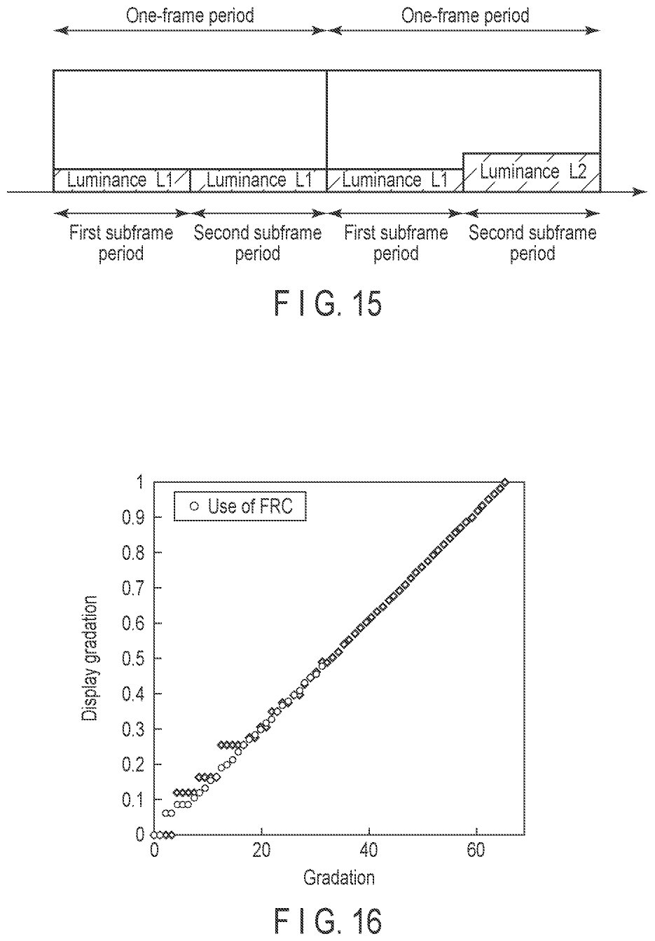

A configuration using the FRC as described above makes it possible to represent the gradation as shown in FIG. 16 in comparison with the gradation shown in FIG. 13.

In the present embodiment, for example, when the gradation of an image to be displayed based on a pixel signal is a lower gradation (that is, it is within a predetermined range in which the gradation cannot be represented in a one-frame period), an operation may be performed to represent one gradation in a plurality of one-frame periods by utilizing the FRC. Note that the number of one-frame periods for representing the gradation may be three or more.

Note that when the number of one-frame periods for representing the gradation is, for example, four, the pattern of luminance to drive each pixel, for example, in units of 4×4 pixels may be changed. Assume here that the luminance pattern in which the pixel PX is driven with luminance L1 in the first subframe period and it is driven with luminance L1 in the second subframe period is, for example, a first luminance pattern. Also, assume that the luminance pattern in which the pixel PX is driven with luminance L1 in the first subframe period and it is driven with luminance L2 in the second subframe period is, for example, a second luminance pattern.

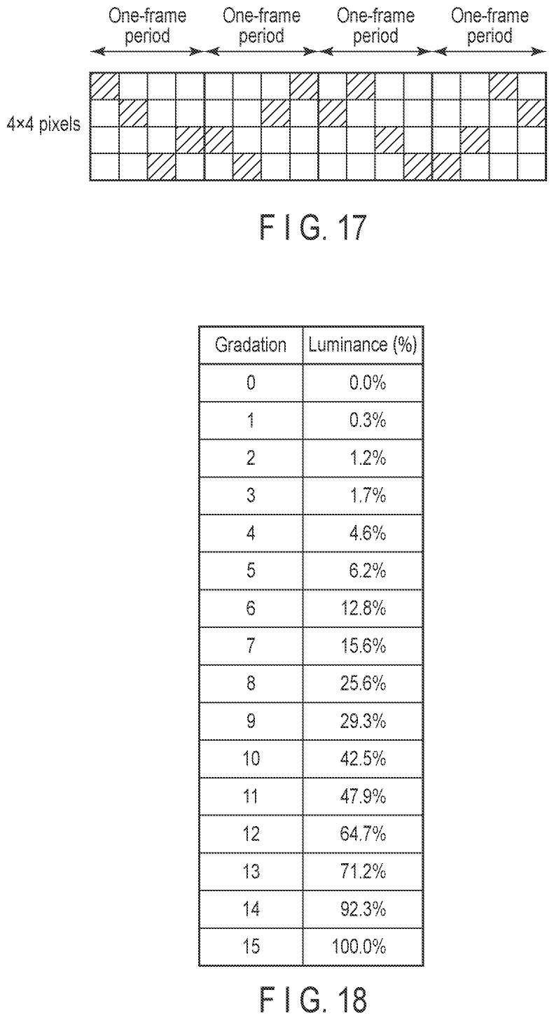

In this case, for example, each pixel PX may be driven by the first luminance pattern in the one-frame period (first and second subframe periods) hatched in FIG. 17, and may be driven by the second luminance pattern in the one-frame period (first and second subframe periods) not hatched.

Specifically, for example, the upper-left pixel PX of the 4×4 pixels shown in FIG. 17 is driven in the order of the first luminance pattern, second luminance pattern, second luminance pattern and second luminance pattern. On the other hand, the lower-right pixel PX of the 4×4 pixels shown in FIG. 17 is driven in the order of the second luminance pattern, second luminance pattern, first luminance pattern and second luminance pattern.

In addition, when there are a plurality of display colors, the phase of the luminance pattern may be changed depending on the colors. This can smooth variations in luminance.

The case where the number of one-frame periods for representing a gradation is four, has been described so far. The number of one-frame periods may be different and so may be the luminance pattern.

In the present embodiment, the luminance with which the pixel PX is driven in each of the subframe periods in accordance with the gradation of an image to be displayed based on a pixel signal, may be selected (determined) in advance as described above. However, the foregoing FRC may be used only when flicker is inconspicuous (in other words, flicker is hard to recognize visually), for example, in consideration of the environment around the display device DSP.

Specifically, when the periphery of the display device DSP is sufficiently bright, flicker is not conspicuous in the lower gradation. Therefore, for example, when the gradation of an image to be displayed based on a pixel signal falls within a predetermined range (that is, lower gradation) and the illuminance around the display device DSP measured by an illuminance sensor or the like falls within a predetermined range (that is, sufficiently bright), the FRC can be used. When the gradation of an image to be displayed based on a pixel signal does not fall within a predetermined range or when the illuminance around the display device DSP does not fall within a predetermined range, the gradation may be represented in a one-frame period (first and second subframe periods) as described above.

In the configuration described above, the illuminance sensor may be incorporated in, for example, the display device DSP, or may be provided outside the display device DSP.

It has been described that flicker is not conspicuous in the lower gradation when the periphery of the display device DSP is sufficiently bright. The gradation in which flicker is not conspicuous may be predetermined from another viewpoint.

It has been described so far that the FRC is used. For example, a dithering process or the like may be further performed.

As described above, in the present embodiment, the display controller 2 drives the pixel PX with the first luminance in the first subframe period among the subframe periods obtained by dividing a one-frame period for displaying an image, and drives the pixel PX with the second luminance in the second subframe period among the subframe periods, thereby displaying the image with a predetermined gradation based on a pixel signal. In addition, a luminance difference between the first luminance of the pixel PX in the first subframe period and the second luminance of the pixel PX in the second subframe period is equal to or smaller than a predetermined value.

In the present embodiment, for example, a gradation corresponding to the average value of the luminance of the pixels PX in the two sub-frame periods can be represented during a one-frame period. It is thus possible to increase the number of gradations that can be represented when an image is displayed. If, furthermore, a luminance difference between the first luminance and the second luminance is set to a predetermined value or less (e.g., two gradations or lower), a flicker based on the luminance difference can be prevented from being visually recognized.

In addition, it is conceivable that the correspondence between voltage and luminance (voltage-luminance characteristics) changes due to, for example, a change in temperature change. In the present embodiment, however, the foregoing luminance difference between the first luminance and the second luminance is reduced to make gradation inversion difficult to occur and to lessen, for example, the influence of individual differences of each component.

In the present embodiment, the average value of the first and second luminances does not overlap with the average value of the luminance of the pixel PX in the first and second subframe periods when an image is displayed in a gradation other than a predetermined gradation of an image represented based on a pixel signal (that is, the first and second luminances are selected so that the average value thereof does not overlap with other combinations). Thus, in the present embodiment, the number of gradations that can be represented can appropriately be increased.

Furthermore, in the present embodiment, when the gradation of an image to be displayed based on a pixel signal falls within a predetermined range such as a lower gradation, the display controller 2 drives the pixel PX with the first luminance in the first subframe period obtained by dividing a one-frame period for displaying an image, drives the pixel PX with the second luminance in the second subframe period obtained by dividing the one-frame period, drives the pixel PX with the third luminance in the third subframe period among the subframe periods obtained by dividing a one-frame period following the one-frame period, and drives the pixel PX with the fourth luminance in the fourth subframe period obtained by dividing the one-frame period.

That is, in the present embodiment, for example, when the gradation of an image to be displayed based on a pixel signal is, for example, a gradation that cannot be appropriately represented (for example, a lower gradation or the like obtained when luminance is selected by giving priority to a higher gradation), it is possible to increase the number of gradations that can be more represented by operating to represent one gradation in a plurality of one-frame periods using FRC. Even when the FRC is used, in order to avoid a flicker, a luminance difference between the luminances of the pixels PX in the subframe periods obtained by dividing the plurality of one-frame periods, is set to a predetermined value.

In the case of using FRC, a flicker may be conspicuous (a flicker is easy to recognize visually). Thus, the display device DSP may be configured to use FRC if the gradation of an image to be displayed based on a pixel signal falls within a predetermined range and the illuminance around the display device DSP measured by an illuminance sensor falls within a predetermined range (that is, a range in which a flicker is inconspicuous). This configuration makes it possible to use FRC only in a gradation in which flicker is inconspicuous (flicker is hardly recognized visually) in consideration of the environment around the display device DSP. On the other hand, for example, when the environment around the display device DSP is sufficiently bright with respect to the luminance (display maximum luminance) corresponding to the maximum gradation, the display device DSP can be configured without using FRC because the influence of a small number of gradations on the lower gradation side is small in many cases.

Furthermore, in the present embodiment, the display controller 2 is configured to drive the pixel PX with a plurality of luminances. It drives the pixel PX with a first luminance among the luminances and drives the pixel PX with a second luminance among the luminances to display an image with a gradation corresponding to the combination of the first and second luminances. Note that the display controller 2 has only to be configured to drive the pixel PX with a plurality of luminances corresponding to the gradation of, for example, 5 bits or less.

It has been described that in the present embodiment, the display controller 2 can represent, for example, 4-bit gradation (can drive the pixel PX with luminance corresponding to the 0th to 15th gradations). According to the present embodiment, however, the display controller 2 can also represent a gradation corresponding to, for example, 6 bits.

In the present embodiment, furthermore, when the pixel PX is driven with the first luminance in a first subframe period obtained by dividing a first one-frame period, the pixel PX is driven with the second luminance in a second subframe period obtained by dividing the first one-frame period, the pixel PX is driven with the third luminance in a third subframe period obtained by dividing the next one-frame period (the second one-frame period), and the pixel PX is driven with the fourth luminance in a fourth subframe period obtained by dividing the next one-frame period, the second luminance is equal to or greater than the first luminance and the fourth luminance is equal to or greater than the third luminance. In the present embodiment, pseudo vibration of images can be avoided by uniforming the luminance change (magnitude relationship) between the subframe periods in each one-frame period.

In the present embodiment, the luminance difference between the first luminance and the second luminance is equal to or less than a predetermined value. However, the first luminance or the second luminance may be selected such that the luminance difference is equal to or less than a predetermined value (for example, within a two-gradation difference) only when the gradation of an image to be displayed based on a pixel signal is a gradation with a conspicuous flicker. Note that the gradation with a conspicuous flicker may be predetermined or determined based on the environment around the display device DSP based on the illuminance measured by the illuminance sensor described above. The process of determining whether or not the gradation of an image to be displayed is a gradation with a conspicuous flicker based on a pixel signal and the process of selecting (a combination of) luminances when the pixel PX is driven based on a pixel signal may be performed by the display controller 2, for example, when the pixel signal is input. According to this configuration, the luminance difference between the first luminance and the second luminance is recued in the gradation with a conspicuous flicker, thus making it possible to inhibit the flicker from being visually recognized. Since, furthermore, the number of choices of the combination of the first and second luminances increases in the gradation with a conspicuous flicker, more appropriate gradation can be represented, and improvement in image quality is expected.

It has been described that in the present embodiment, a one-frame period is divided into two subframe periods (first and second subframe periods). The one-frame period may be divided into three or more subframe periods.

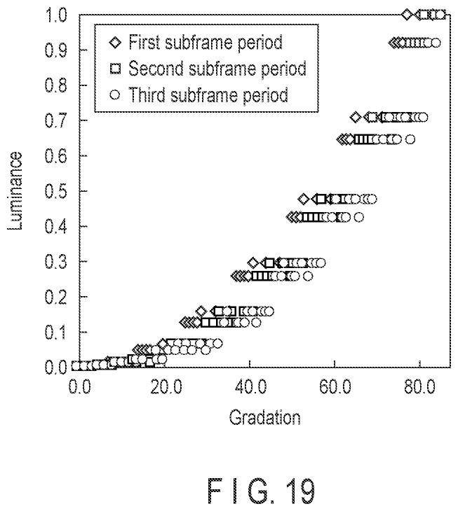

FIG. 18 shows an example of luminance corresponding to each of the 0th to 15th gradations that can be represented by the display controller 2 when a one-frame period is divided into three subframe periods. FIG. 19 shows the distribution of luminances of the pixel PX in each of the first to third subframe periods selected to represent each of the gradations when a one-frame period is divided into three subframe periods (the first to third subframe periods). According to the examples shown in FIGS. 17 and 18, when a one-frame period is divided into three subframe periods, for example, the 0th to 80th or more gradations (that is, gradations corresponding to 6 to 7 bits) can be represented.

When the number of subframe periods into which one frame period is divided is increased as described above, the number of gradations can be further increased.

Note that even when the number of subframe periods is increased, the display device DSP can be configured to use the FRC described above, for example.

It has been described that in the present embodiment, the display device DSP which including a liquid crystal layer LC containing the polymer 31 having a strip-shaped structure (to which a polymer dispersed liquid crystal is applied). The present embodiment may be applied to a display device (liquid crystal display device) including another liquid crystal layer.

Furthermore, the present embodiment may be applied to a display device other than the liquid crystal display device such as an organic EL display device and an LED display device, as long as a one-frame period is divided into a plurality of subframe periods and a pixel PX is driven in each of the subframe periods to increase the number of gradations that can be represented.

Hereinafter, the inventions according to the embodiments will be noted below.

[C1]

A display device including:

a display panel provided with a pixel; and

a display controller configured to drive the pixel based on a pixel signal for displaying an image in a predetermined gradation to display the image,

wherein:

the display controller is configured to drive the pixel with first luminance during a first subframe period of a plurality of subframe periods into which a one-frame period for displaying the image is divided and drive the pixel with second luminance during a second subframe period other than the first subframe period of the plurality of subframe periods to display the image in the predetermined gradation; and

a luminance difference between the first luminance and the second luminance is equal to or less than a predetermined value.

[C2]

The display device of [C1], wherein an average value of the first luminance and the second luminance does not overlap with an average value of luminances of the pixel in each of the first subframe and the second subframe when an image is displayed in a gradation other than the predetermined gradation.

[C3]

The display device of [C1], wherein when a gradation of an image to be displayed based on the image signal falls within a predetermined range, the display controller is configured to display the image in the gradation by driving the pixel with the first luminance during a first subframe period of a plurality of subframe periods into which a one-frame period for displaying the image is divided, driving the pixel with the second luminance during a second subframe period other than the first subframe period of the plurality of subframe periods, driving the pixel with third luminance during a third subframe period of a plurality of subframe periods into which a one-frame period subsequent to the one-frame period is divided, and driving the pixel with fourth luminance during a fourth subframe period other than the third subframe periods of the plurality of subframe periods into which the subsequent one-frame period is divided; and

a luminance difference between the first luminance, the second luminance, the third luminance and the fourth luminance is equal to or less than a predetermined value.

[C4]

The display device of [C1], wherein:

when a gradation of an image to be displayed based on the image signal falls within a predetermined first range and illuminance around the display device measured by an illuminance sensor falls within a predetermined second range, the display controller is configured to drive the pixel with the first luminance during the first subframe period, drive the pixel with the second luminance during the second subframe period, drive the pixel with third luminance during the third subframe period, and drive the pixel with the fourth luminance during the fourth subframe period; and

when the gradation of an image to be displayed based on the image signal does not fall within the first range or the illuminance around the display device measured by the illuminance sensor does not fall within the second range, the display controller is configured to drive the pixel with the first luminance during the first subframe period and drive the pixel with the second luminance during the second subframe period.

[C5]

The display device of [C1], wherein the display controller is configured to drive the pixel with the first luminance of a plurality of luminances which the pixel is driven and drive the pixel with the second luminance of the plurality of luminances to display the image in a gradation corresponding to a combination of the first luminance and the second luminance.

[C6]

The display device of [C5], wherein the display controller is configured to drive the pixel with a plurality of luminances corresponding to a gradation of 5 bits or less.

[C7]

The display device of [C6], wherein:

the display panel includes a first substrate, a second substrate opposed to the first substrate, and a liquid crystal layer interposed between the first substrate and the second substrate; and

the display controller is configured to apply a voltage to the liquid crystal layer to drive the pixel.

[C8]

The display device of [C7], wherein the liquid crystal layer includes a polymer having a strip-shaped structure.

[C9]

The display device of [C8], further including:

a plurality of light emitting elements having different light emitting colors; and

a light source driver configured to cause the light emitting elements to emit light in time division such that the light enters the liquid crystal layer,

wherein the display controller is configured to drive the pixel to emit the light from the liquid crystal layer.

[C10]

A display device including:

a display panel provided with a plurality of pixels; and

a display controller configured to drive the pixels based on a pixel signal for displaying an image in a predetermined gradation to display the image,

wherein:

based on a pixel image for displaying a first image in a first gradation, the display controller is configured to drive each of the pixels with first luminance during a first subframe period of a plurality of subframe periods into which a one-frame period for displaying the first image is divided and drive each of the pixels with second luminance during a second subframe period other than the first subframe period of a plurality of subframe periods into which a one-frame period for displaying the first image is divided to display the first image in the first gradation;

based on a pixel image for displaying a second image in a second gradation, the display controller is configured to drive each of the pixels with third luminance during a third subframe period of a plurality of subframe periods into which a one-frame period for displaying the second image is divided and drive each of the pixels with fourth luminance during a fourth subframe period other than the third subframe period of a plurality of subframe periods into which a one-frame period for displaying the second image is divided to display the first image in the second gradation;

a luminance difference between the first luminance and the second luminance is equal to or less than a predetermined value;

a luminance difference between the third luminance and the fourth luminance is equal to or less than the predetermined value; and

a magnitude relationship between the first luminance and the second luminance when the second subframe period is later than the first subframe period is equal to a magnitude relationship between the third luminance and the fourth luminance when the fourth subframe period is later than the third subframe period.

[C11]

A method executed by a display device including a display panel provided with a pixel and a display controller configured to drive the pixel based on a pixel signal for displaying an image in a predetermined gradation to display the image, the method including:

driving the pixel with first luminance during a first subframe period of a plurality of subframe periods into which a one-frame period for displaying the image is divided;

driving the pixel with second luminance during a second subframe period other than the first subframe period of the plurality of subframe periods, based on the image signal; and

displaying the image in the predetermined gradation corresponding to the first luminance and the second luminance,

wherein a luminance difference between the first luminance and the second luminance is equal to or less than a predetermined value.

[C12]

The method of [C11], wherein an average value of the first luminance and the second luminance does not overlap with an average value of luminances of the pixel in each of the first subframe and the second subframe when an image is displayed in a gradation other than the predetermined gradation.

[C13]

The method of [C11], including, when a gradation of an image to be displayed based on the image signal falls within a predetermined range, driving the pixel with the first luminance during the first subframe period of a plurality of subframe periods into which a one-frame period for displaying the image is divided, driving the pixel with the second luminance during a second subframe period other than the first subframe period of the plurality of subframe periods, driving the pixel with third luminance during a third subframe period of a plurality of subframe periods into which a one-frame period subsequent to the one-frame period is divided, and driving the pixel with fourth luminance during a fourth subframe period other than the third subframe periods of the plurality of subframe periods into which the subsequent one-frame period is divided,

wherein a luminance difference between the first luminance, the second luminance, the third luminance and the fourth luminance is equal to or less than a predetermined value.

[C14]

The method of [C13], wherein the driving includes:

when a gradation of an image to be displayed based on the image signal falls within a predetermined first range and illuminance around the display device measured by an illuminance sensor falls within a predetermined second range, driving the pixel with the first luminance during the first subframe period, driving the pixel with the second luminance during the second subframe period, driving the pixel with third luminance during the third subframe period, and driving the pixel with the fourth luminance during the fourth subframe period; and

when the gradation of an image to be displayed based on the image signal does not fall within the first range or the illuminance around the display device measured by the illuminance sensor does not fall within the second range, driving the pixel with the first luminance during the first subframe period and driving the pixel with the second luminance during the second subframe period.

[15]

The method of [C11], wherein:

the display controller is configured to drive the pixel with a plurality of luminances; and

the driving the pixel with the first luminance includes driving the pixel with first luminance of the luminances;

the driving the pixel with the second luminance includes driving the pixel with second luminance of the luminances; and

the displaying includes displaying the image in a gradation corresponding to a combination of the first luminance and the second luminance.

[C16]

The method of [C15], wherein the display controller is configured to drive the pixel with a plurality of luminances corresponding to a gradation of 5 bits or less.

[C17]

The method of [C16], wherein:

the display panel includes a first substrate, a second substrate opposed to the first substrate, and a liquid crystal layer interposed between the first substrate and the second substrate; and

the driving the pixel includes applying a voltage to the liquid crystal layer to drive the pixel.

[C18]

The method of [C17], wherein the liquid crystal layer includes a polymer having a strip-shaped structure.

[C19]

The method of [C18], wherein:

the display device includes a plurality of light emitting elements having different light emitting colors;

the method further includes causing the light emitting elements to emit light in time division such that the light enters the liquid crystal layer; and

the driving the pixel includes driving the pixel to emit the light from the liquid crystal layer.

[C20]

A method executed by a display device including a display panel provided with a plurality of pixels and a display controller configured to drive the pixels based on a pixel signal for displaying an image in a predetermined gradation to display the image, the method including:

based on a pixel image for displaying a first image in a first gradation, driving each of the pixels with first luminance during a first subframe period of a plurality of subframe periods into which a one-frame period for displaying the first image is divided;

based on a pixel image for displaying the first image in the first gradation, driving each of the pixels with second luminance during a second subframe period other than the first subframe period of a plurality of subframe periods into which a one-frame period for displaying the first image is divided;

displaying the image in the first gradation corresponding to the first luminance and the second luminance;

based on a pixel image for displaying a second image in a second gradation, driving each of the pixels with third luminance during a third subframe period of a plurality of subframe periods into which a one-frame period for displaying the second image is divided;

based on a pixel image for displaying the second image in the second gradation, driving each of the pixels with fourth luminance during a fourth subframe period other than the third subframe period of a plurality of subframe periods into which a one-frame for displaying the second is divided; and

displaying the image in the second gradation corresponding to the third luminance and the fourth luminance,

wherein:

a luminance difference between the first luminance and the second luminance is equal to or less than a predetermined value;

a luminance difference between the third luminance and the fourth luminance is equal to or less than the predetermined value; and

a magnitude relationship between the first luminance and the second luminance when the second subframe period is later than the first subframe period is equal to a magnitude relationship between the third luminance and the fourth luminance when the fourth subframe period is later than the third subframe period.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
a display panel provided with a pixel; and
a display controller configured to drive the pixel based on a pixel signal for displaying an image in a predetermined gradation to display the image,
wherein:
the display controller is configured to drive the pixel with first luminance during a first subframe period of a plurality of subframe periods into which a one-frame period for displaying the image is divided and drive the pixel with second luminance during a second subframe period other than the first subframe period of the plurality of subframe periods to display the image in the predetermined gradation; and
a luminance difference between the first luminance and the second luminance is equal to or less than a predetermined value.

2. The display device of claim 1, wherein an average value of the first luminance and the second luminance does not overlap with an average value of luminances of the pixel in each of the first subframe and the second subframe when an image is displayed in a gradation other than the predetermined gradation.

3. The display device of claim 1, wherein when a gradation of an image to be displayed based on the image signal falls within a predetermined range, the display controller is configured to display the image in the gradation by driving the pixel with the first luminance during a first subframe period of a plurality of subframe periods into which a one-frame period for displaying the image is divided, driving the pixel with the second luminance during a second subframe period other than the first subframe period of the plurality of subframe periods, driving the pixel with third luminance during a third subframe period of a plurality of subframe periods into which a one-frame period subsequent to the one-frame period is divided, and driving the pixel with fourth luminance during a fourth subframe period other than the third subframe periods of the plurality of subframe periods into which the subsequent one-frame period is divided; and
a luminance difference between the first luminance, the second luminance, the third luminance and the fourth luminance is equal to or less than a predetermined value.

4. The display device of claim 1, wherein:
when a gradation of an image to be displayed based on the image signal falls within a predetermined first range and illuminance around the display device measured by an illuminance sensor falls within a predetermined second range, the display controller is configured to drive the pixel with the first luminance during the first subframe period, drive the pixel with the second luminance during the second subframe period, drive the pixel with third luminance during the third subframe period, and drive the pixel with the fourth luminance during the fourth subframe period; and
when the gradation of an image to be displayed based on the image signal does not fall within the first range or the illuminance around the display device measured by the illuminance sensor does not fall within the second range, the display controller is configured to drive the pixel with the first luminance during the first subframe period and drive the pixel with the second luminance during the second subframe period.

5. The display device of claim 1, wherein the display controller is configured to drive the pixel with the first luminance of a plurality of luminances which the pixel is driven and drive the pixel with the second luminance of the plurality of luminances to display the image in a gradation corresponding to a combination of the first luminance and the second luminance.

6. The display device of claim 5, wherein the display controller is configured to drive the pixel with a plurality of luminances corresponding to a gradation of 5 bits or less.

7. The display device of claim 6, wherein:
the display panel includes a first substrate, a second substrate opposed to the first substrate, and a liquid crystal layer interposed between the first substrate and the second substrate; and
the display controller is configured to apply a voltage to the liquid crystal layer to drive the pixel.

8. The display device of claim 7, wherein the liquid crystal layer includes a polymer having a strip-shaped structure.

9. The display device of claim 8, further comprising:
a plurality of light emitting elements having different light emitting colors; and
a light source driver configured to cause the light emitting elements to emit light in time division such that the light enters the liquid crystal layer,
wherein the display controller is configured to drive the pixel to emit the light from the liquid crystal layer.

10. A display device comprising:
a display panel provided with a plurality of pixels; and
a display controller configured to drive the pixels based on a pixel signal for displaying an image in a predetermined gradation to display the image,
wherein:
based on a pixel image for displaying a first image in a first gradation, the display controller is configured to drive each of the pixels with first luminance during a first subframe period of a plurality of subframe periods into which a one-frame period for displaying the first image is divided and drive each of the pixels with second luminance during a second subframe period other than the first subframe period of a plurality of subframe periods into which a one-frame period for displaying the first image is divided to display the first image in the first gradation;
based on a pixel image for displaying a second image in a second gradation, the display controller is configured to drive each of the pixels with third luminance during a third subframe period of a plurality of subframe periods into which a one-frame period for displaying the second image is divided and drive each of the pixels with fourth luminance during a fourth subframe period other than the third subframe period of a plurality of subframe periods into which a one-frame period for displaying the second image is divided to display the first image in the second gradation;
a luminance difference between the first luminance and the second luminance is equal to or less than a predetermined value;
a luminance difference between the third luminance and the fourth luminance is equal to or less than the predetermined value; and
a magnitude relationship between the first luminance and the second luminance when the second subframe period is later than the first subframe period is equal to a magnitude relationship between the third luminance and the fourth luminance when the fourth subframe period is later than the third subframe period.

11. A method executed by a display device comprising a display panel provided with a pixel and a display controller configured to drive the pixel based on a pixel signal for displaying an image in a predetermined gradation to display the image, the method comprising:
driving the pixel with first luminance during a first subframe period of a plurality of subframe periods into which a one-frame period for displaying the image is divided;
driving the pixel with second luminance during a second subframe period other than the first subframe period of the plurality of subframe periods, based on the image signal; and
displaying the image in the predetermined gradation corresponding to the first luminance and the second luminance,
wherein a luminance difference between the first luminance and the second luminance is equal to or less than a predetermined value.

12. The method of claim 11, wherein an average value of the first luminance and the second luminance does not overlap with an average value of luminances of the pixel in each of the first subframe and the second subframe when an image is displayed in a gradation other than the predetermined gradation.

13. The method of claim 11, comprising, when a gradation of an image to be displayed based on the image signal falls within a predetermined range, driving the pixel with the first luminance during the first subframe period of a plurality of subframe periods into which a one-frame period for displaying the image is divided, driving the pixel with the second luminance during a second subframe period other than the first subframe period of the plurality of subframe periods, driving the pixel with third luminance during a third subframe period of a plurality of subframe periods into which a one-frame period subsequent to the one-frame period is divided, and driving the pixel with fourth luminance during a fourth subframe period other than the third subframe periods of the plurality of subframe periods into which the subsequent one-frame period is divided,
wherein a luminance difference between the first luminance, the second luminance, the third luminance and the fourth luminance is equal to or less than a predetermined value.

14. The method of claim 13, wherein the driving includes:
when a gradation of an image to be displayed based on the image signal falls within a predetermined first range and illuminance around the display device measured by an illuminance sensor falls within a predetermined second range, driving the pixel with the first luminance during the first subframe period, driving the pixel with the second luminance during the second subframe period, driving the pixel with third luminance during the third subframe period, and driving the pixel with the fourth luminance during the fourth subframe period; and
when the gradation of an image to be displayed based on the image signal does not fall within the first range or the illuminance around the display device measured by the illuminance sensor does not fall within the second range, driving the pixel with the first luminance during the first subframe period and driving the pixel with the second luminance during the second subframe period.

15. The method of claim 11, wherein:
the display controller is configured to drive the pixel with a plurality of luminances; and
the driving the pixel with the first luminance includes driving the pixel with first luminance of the luminances;
the driving the pixel with the second luminance includes driving the pixel with second luminance of the luminances; and
the displaying includes displaying the image in a gradation corresponding to a combination of the first luminance and the second luminance.

16. The method of claim 15, wherein the display controller is configured to drive the pixel with a plurality of luminances corresponding to a gradation of 5 bits or less.

17. The method of claim 16, wherein:
the display panel includes a first substrate, a second substrate opposed to the first substrate, and a liquid crystal layer interposed between the first substrate and the second substrate; and
the driving the pixel includes applying a voltage to the liquid crystal layer to drive the pixel.

18. The method of claim 17, wherein the liquid crystal layer includes a polymer having a strip-shaped structure.

19. The method of claim 18, wherein:
the display device includes a plurality of light emitting elements having different light emitting colors;
the method further comprises causing the light emitting elements to emit light in time division such that the light enters the liquid crystal layer; and
the driving the pixel includes driving the pixel to emit the light from the liquid crystal layer.

20. A method executed by a display device comprising a display panel provided with a plurality of pixels and a display controller configured to drive the pixels based on a pixel signal for displaying an image in a predetermined gradation to display the image, the method comprising:
based on a pixel image for displaying a first image in a first gradation, driving each of the pixels with first luminance during a first subframe period of a plurality of subframe periods into which a one-frame period for displaying the first image is divided;
based on a pixel image for displaying the first image in the first gradation, driving each of the pixels with second luminance during a second subframe period other than the first subframe period of a plurality of subframe periods into which a one-frame period for displaying the first image is divided;
displaying the image in the first gradation corresponding to the first luminance and the second luminance;
based on a pixel image for displaying a second image in a second gradation, driving each of the pixels with third luminance during a third subframe period of a plurality of subframe periods into which a one-frame period for displaying the second image is divided;
based on a pixel image for displaying the second image in the second gradation, driving each of the pixels with fourth luminance during a fourth subframe period other than the third subframe period of a plurality of subframe periods into which a one-frame for displaying the second is divided; and
displaying the image in the second gradation corresponding to the third luminance and the fourth luminance,
wherein:
a luminance difference between the first luminance and the second luminance is equal to or less than a predetermined value;
a luminance difference between the third luminance and the fourth luminance is equal to or less than the predetermined value; and
a magnitude relationship between the first luminance and the second luminance when the second subframe period is later than the first subframe period is equal to a magnitude relationship between the third luminance and the fourth luminance when the fourth subframe period is later than the third subframe period.
